(19) United States
(12) Patent Application Publication
(10) Pub. No.: US 2025/0207316 A1
(43) Pub. Date: Jun. 26, 2025

(54) CLOTHES DRYER

(71) Applicant: SAMSUNG ELECTRONICS CO., LTD., Suwon-si (KR)

(72) Inventors: Gihyun LEE, Suwon-si (KR); Hyeonuk NA, Suwon-si (KR); Minjung KIM, Suwon-si (KR); Naeyoung PARK, Suwon-si (KR)

(73) Assignee: SAMSUNG ELECTRONICS CO., LTD., Suwon-si (KR)

(21) Appl. No.: 19/078,403

(22) Filed: Mar. 13, 2025

Related U.S. Application Data
(63) Continuation of application No. PCT/KR2023/010919, filed on Jul. 27, 2023.

(30) Foreign Application Priority Data
Sep. 21, 2022 (KR) 10-2022-0119656

(51) Int. Cl. D06F 58/20

(52) U.S. Cl. CPC D06F 58/20

(57) ABSTRACT

A clothes dryer including a cabinet including an inlet, and a door rotatably arranged on the cabinet to open or close the inlet. The door includes a holder rotatably arranged on the cabinet, a front cover, a cover supporter to be coupled to the holder so that the cover supporter is arranged between the front cover and the holder to support the front cover, a first rim cover to be coupled to the front cover so that the first rim cover covers a rim of the front cover, and a second rim cover configured to be coupled to a rim of the holder so that the second rim cover is connected to the first rim cover. The first rim cover is separable from the second rim cover by separating the cover supporter from the holder.

### CROSS-REFERENCE TO RELATED APPLICATION

This application is a continuation application, under 35 U.S.C. § 111(a), of international application No. PCT/KR2023/010919, filed Jul. 27, 2023, which claims priority under 35 U. S. C. § 119 to Korean Patent Application No. 10-2022-0119656, filed Sep. 21, 2022, the disclosures of which are incorporated herein by reference in their entireties.

### TECHNICAL FIELD

The disclosure relates to a clothes dryer, and more particularly, to a door of a clothes dryer.

### BACKGROUND ART

In general, a dryer, such as a clothes dryer, is an appliance that dries laundry using hot dry air. The dryer is provided for drying an object to be dried by rotating a drum in which the object to be dried is received at a low speed while allowing hot air to pass through the inside of the drum.

The dryer includes a cabinet forming an exterior thereof, a drum rotatably installed in the cabinet, a drive unit for driving the drum, and a hot air supply unit that supplies hot air to the inside of the rotating drum.

When the dryer is operated after the object to be dried is placed inside the drum, the operation of the drive unit causes the drum to rotate and, at the same time, the hot air supply unit supplies hot air to the drum, thereby drying the object to be dried inside the drum.

### DISCLOSURE

### Technical Problem

An embodiment of the present disclosure provides a clothes dryer including a structure in which a first rim cover of a door is removable.

An embodiment of the present disclosure provides a clothes dryer including a structure in which a door hinge is coupled anywhere on either side of a holder.

Technical tasks to be achieved in this document are not limited to the technical tasks mentioned above, and other technical tasks not mentioned will be clearly understood by those skilled in the art from the description below.

### Technical Solution

According to an embodiment of the disclosure, a clothes dryer includes a cabinet including an inlet, and a door to be rotatably arranged on the cabinet to open or close the inlet. The door includes a holder to be rotatably arranged on the cabinet, a front cover, a cover supporter to be coupled to the holder so that while the cover supporter is coupled to the holder, the cover supporter is arranged between the front cover and the holder to support the front cover, a first rim cover coupleable to the front cover so that while the first rim cover is coupled to the front cover, the first rim cover covers a rim of the front cover, and a second rim cover configured to be coupled to a rim of the holder so that while the second rim cover is coupled to the holder, the second rim cover is connected to the first rim cover. The first rim cover is separable from the second rim cover by separating the cover supporter from the holder.

The first rim cover may be coupleable to the cover supporter. The first rim cover while coupled to the front cover and the cover supporter may be separated from the second rim cover by separating the cover supporter from the second rim cover.

The cover supporter may include an insertion protrusion protruding toward the first rim cover to be coupleable to the first rim cover. The first rim cover may include an insertion hole formed to allow the insertion protrusion to be inserted.

The front cover may include a coupling hole. The first rim cover may include a coupling protrusion formed to be inserted into the coupling hole of the front cover.

The clothes dryer according to an embodiment may further include a door hinge configured to rotate the door relative to the cabinet, and the door may include a holder coupling portion coupled to the holder. The holder may include a seat portion formed to allow the holder coupling portion to be seated, and a support portion configured to support the holder coupling portion and protruding from a rim of the seat portion.

The seat portion and the support portion may be a first seat portion and a first support portion, respectively. The first seat portion and the first support portion may be formed on one side of the holder. The holder may further include a second seat portion corresponding to the first seat portion and formed on another side of the holder, and a second support portion corresponding to the first support portion and formed on the other side of the holder.

The holder coupling portion may be seated on one of the first seat portion and the second seat portion.

The door hinge seated on the first seat portion may be enabled to be seated on the second seat portion by separating the second rim cover from the cover supporter.

The door hinge seated on the second seat portion may be supported by the second support portion by separating the second rim cover from the cover supporter.

The second rim cover may include a guide rib formed to be caught on either the first support portion or the second support portion.

The guide rib may be formed on one side of the second rim cover. The guide rib may protrude toward the seat portion.

The second rim cover may be coupleable to the holder as the door hinge rotates relative to the holder.

The first rim cover may include a first guide portion configured to guide a position of the front cover to allow the coupling protrusion to be inserted into the coupling hole. The front cover may include a second guide portion formed at a position corresponding to the first guide portion.

The second rim cover may further include a handle portion formed on one side adjacent to the guide rib.

The clothes dryer according to an embodiment may further include a rear cover positioned further rearwardly than the holder and formed of iron (Fe).

According to an embodiment of the disclosure, a clothes dryer includes a cabinet including an inlet, and a door rotatably arranged on the cabinet to open or close the inlet. The door includes a holder rotatably coupleable on the cabinet, a front cover configured to cover the inlet, a cover supporter arranged between the front cover and the holder to support the front cover and the cover supporter being coupleable to the holder, a door hinge coupleable to the holder to allow the holder to rotate relative to the cabinet, a first rim cover coupleable to the front cover to cover a rim of the front cover, and a second rim cover extending along a rim of the holder to be connectable with the first rim cover and the second rim cover being configured to cover a rear side of the door hinge to support the door hinge. The second rim cover is coupleable to the cover supporter through the holder, and the second rim cover is rotated with respect to the holder and coupled to the holder by separating the second rim cover from the cover supporter.

The first rim cover may be separated from the second rim cover by separating the cover supporter from the holder.

The first rim cover may be separated from the second rim cover by separating the second rim cover from the cover supporter.

The door hinge may include a holder coupling portion coupled to the holder. The holder may include a first seating groove formed on one side to allow the holder coupling portion to be seated thereon, a second seating groove corresponding to the first seating groove and formed on the other end, and a support portion protruding from a rim of the second seating groove. The second rim cover may include a guide rib protruding toward the holder to be caught on the support portion.

According to an embodiment of the disclosure, a clothes dryer includes a cabinet including an inlet, and a door rotatably arranged on the cabinet. The door includes a holder rotatably arranged on the cabinet, a front cover in a circular shape to cover the inlet, a cover supporter arranged between the front cover and the holder to support the front cover and coupleable to the holder, a first rim cover extending along a rim of the front cover and coupleable to the front cover and the cover supporter, and a second rim cover extending along a rim of the holder to be connectable to the first rim cover and coupleable to the cover supporter. The first rim cover is separated from the second rim cover by separating the second rim cover from the cover supporter.

### Advantageous Effects

According to the spirit of the present disclosure, the first rim cover of the door is detachable from the second rim cover and thus serviceability can be improved by reducing the cost or parts required for replacement.

According to the spirit of the present disclosure, a guide portion of the front cover and the first rim cover is provided, so that coupling of the front cover and the first rim cover can be facilitated.

According to the spirit of the present disclosure, the appearance of the door can be improved as the second rim cover includes a structure for hanging on the holder.

The effects to be obtained from the present disclosure are not limited to those mentioned above, and other effects not mentioned will be apparent to a person skilled in the art to which the present disclosure belongs from the following description.

### DESCRIPTION OF DRAWINGS

FIG. 1 is a perspective view of a clothes dryer according to an embodiment of the present disclosure.

FIG. 2 is a perspective view of the clothes dryer according to an embodiment of the present disclosure with a door open.

FIG. 3 is a side cross-sectional view of the clothes dryer according to an embodiment of the present disclosure shown in FIG. 1.

FIG. 4 is a perspective view of the door of the clothes dryer according to an embodiment of the present disclosure shown in FIG. 1.

FIG. 5 is a rear perspective view of the door of the clothes dryer according to an embodiment of the present disclosure shown in FIG. 4.

FIG. 6 is an exploded perspective view of the door of the clothes dryer according to an embodiment of the present disclosure shown in FIG. 4.

FIG. 7 is an exploded perspective view of the door of the clothes dryer according to an embodiment of the present disclosure shown in FIG. 6, viewed from the rear.

FIG. 8 is a rear view illustrating a state in which the front cover and the first rim cover are coupled, according to an embodiment of the present disclosure shown in FIG. 7.

FIG. 9 is an enlarged view of portion A of the front cover and the first forest cover according to an embodiment of the present disclosure shown in FIG. 8.

FIG. 10 is an enlarged view of portion B of the front cover and the first forest cover according to an embodiment of the present disclosure shown in FIG. 8.

FIG. 11 is a rear view illustrating a state in which the front cover, the first rim cover, and a cover supporter are coupled, according to an embodiment of the present disclosure shown in FIG. 7.

FIG. 12 is an enlarged view of portion C of the first forest cover and the cover supporter according to an embodiment of the present disclosure shown in FIG. 11.

FIG. 13 is a rear view illustrating a state in which the front cover, the first rim cover, the cover supporter, and the holder are coupled, according to an embodiment of the present disclosure shown in FIG. 7.

FIG. 14 is an enlarged view of a holder coupling portion of a door hinge according to an embodiment of the present disclosure shown in FIG. 13.

FIG. 15 is a rear view of the door according to an embodiment of the present disclosure shown in FIG. 4.

FIG. 16 is a side cross-sectional view of the door according to an embodiment of the present disclosure shown in FIG. 15.

FIG. 17 is an enlarged view of portion D shown in FIG. 16 according to an embodiment of the present disclosure.

FIG. 18 is a perspective view illustrating an exploded cross-section of the door according to an embodiment of the present disclosure shown in FIG. 15.

FIG. 19 is a front view illustrating a second rim cover according to an embodiment of the present disclosure shown in FIG. 4, with the front cover and the cover supporter and the first rim cover omitted.

FIG. 20 is an enlarged perspective view of portion E shown in FIG. 19 according to an embodiment of the present disclosure.

FIGS. 21 and 22 are rear views illustrating reverse operation of the door according to an embodiment of the present disclosure.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Also, in the accompanying drawings, “F” stands for “Front” and may refer to a front, “R” stands for “Right” and may refer to a right side, and “U” stands for “Up” and may refer to an upper side.

As used herein, the terms “front”, “rear”, “upper”, “lower”, “left”, “right”, and the like are defined with reference to the drawings and are not intended to limit the shape and location of each component.

Hereinafter, various embodiments of the present disclosure will be described in detail with reference to the accompanying drawings.

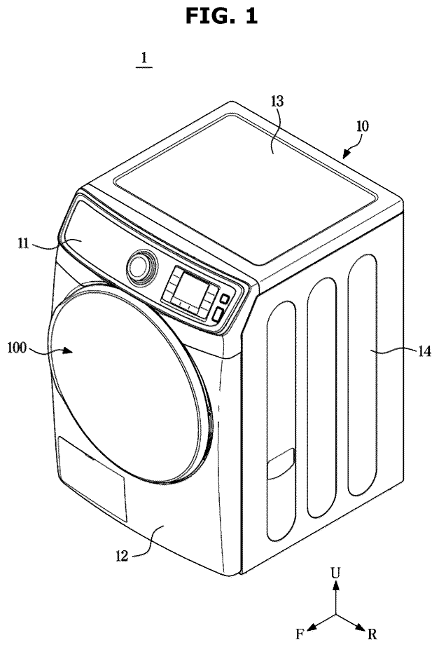

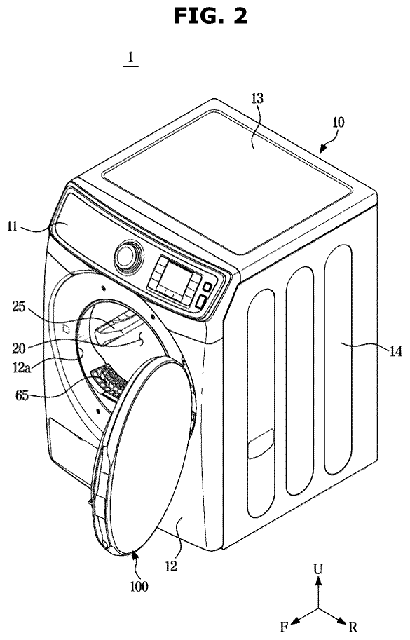

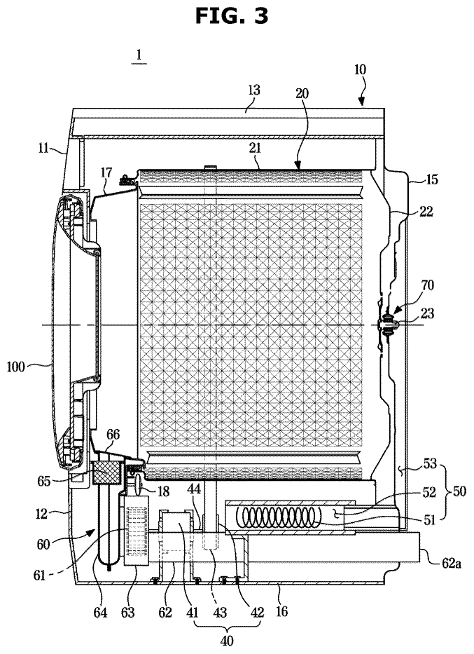

FIG. 1 is a perspective view of a clothes dryer according to an embodiment of the present disclosure. FIG. 2 is a perspective view of the clothes dryer according to an embodiment of the present disclosure with an open door. FIG. 3 is a cross-sectional side view of the clothes dryer according to an embodiment of the present disclosure shown in FIG. 1.

Referring to FIGS. 1 to 3, a dryer 1, for example a clothes dryer, may include a cabinet 10 forming an exterior thereof and a drum 20 rotatably installed within the cabinet 10.

The cabinet 10 may be provided in an approximately hexahedral shape. An inlet 31 may be formed on a front side of the cabinet 10 for taking clothes (not shown), which are items to be dried, into or out of the drum 20. The inlet 31 may be opened and closed by a door 100.

A control panel 11 for controlling the operation of the clothes dryer 1 may be arranged on an upper front side of the cabinet 10. The control panel 11 may be provided with an input section in the form of a rotatable jog dial for inputting the operation of the clothes dryer 1, and a display section for displaying various information about the clothes dryer 1. However, the present disclosure is not limited thereto, and the control panel may include various types of input sections and display sections.

The cabinet 10 may include a front plate 12 forming a front surface, an upper plate 13 forming an upper surface, a side plate 14 forming a side surface, a rear plate 15 covering a rear surface, and a lower plate 16 forming a lower surface. According to an embodiment, the front plate 12 forming the front of the cabinet 10 may be separately assembled with the upper plate 13, the side plate 14, the rear plate 15, and the lower plate 16. Alternatively, at least two of the front plate 12, the upper plate 13, the side plates 14, the rear plate 15, and the lower plate 16 may be formed integrally.

The cabinet 10 may include an inlet 12a arranged on the front plate 12 to allow the items to be dried such as clothes to be inserted into the drum 20 or removed from the inside of the drum 20, and the control panel 11 arranged on the upper side of the front plate 12 to display various information about the clothes dryer 1 or to input operation commands.

On an inner front side of the cabinet 10, a front support frame 17 corresponding to an opening of a body 21 may be arranged. The front support frame 17 may form the inlet 12a.

The drum 20 may be rotatably coupled to the front support frame 17. The drum 20 may include the body 21 formed as a hollow cylindrical shape with an open front and rear, and a rear wall 22 configured to cover a rear side of the open body 21.

In addition, the drum 20 may include a shaft 23 installed at the center of the rear wall 22 to form a center of rotation of the drum 20 to enable the drum 20 to be rotatably installed on the rear plate 15, and a shaft flange (not shown) to enable the shaft 23 to be securely fixedly installed on the rear wall 22.

The shaft 23 may be secured to the drum 20 via the shaft flange, which is fixed to the rear wall 22 of the drum 20, and rotate together with the drum 20. The shaft flange may be fixed to the rear wall 22 of the drum 20 by a plurality of fasteners.

The drum 20 may include a lifter 25 arranged on an inner circumferential surface of the body 21 to allow the items to be dried to be lifted upwardly. A plurality of lifters 25 may be arranged to be spaced apart from each other in a circumferential direction. Accordingly, as the drum 20 rotates, the items to be dried may be repeatedly lifted upwardly and then dropped downwardly by the lifters 25. As a result, the rotation of the drum may inevitably create an unbalanced load on the drum 20.

As described above, the unbalanced load may be inevitably generated in the drum 20 in the process of lifting and dropping of the items to be dried within the drum 20, and the drum 20 may vibrate due to such unbalanced loads.

Accordingly, a roller 18 supporting a lower portion of the front side of the drum 20 may be arranged on the inside of the cabinet 10. The roller 18 may be arranged on the inner front side lower portion of the cabinet 10 to allow the drum 20 to rotate smoothly. The arrangement and number of the rollers 18 may be varied.

The clothes dryer 1 may further include a drive unit 40 for rotating the drum 20.

The drive unit 40 may include a drive motor 41 installed in the inner lower portion of the cabinet 10, and a pulley 42 and a belt 43 for transmitting the power of the drive motor 41 to the drum 20.

The pulley 42 may be connected to a shaft 44 of the drive motor 41, such that the pulley 42 may rotate in response to rotation of the drive motor 41.

The belt 43 may be installed to be wound around the outer surface of the pulley 42 and the outer surface of the drum 20, and thus the drum 20 may rotate together with the belt 43 in response to the rotation of the pulley.

The clothes dryer 1 may include a hot air supply unit 50 for supplying hot air into the drum 20 and a hot air discharge unit 60 for discharging air having dried the items to be dried (e.g., clothes, laundry) inside the drum 20.

Accordingly, hot dry air may be supplied into the drum 20 by the hot air supply unit 50, such that the items to be dried inside the drum 20 may be dried by the hot dry air. The air having absorbed moisture from the items to be dried may become hot and humid, and then be discharged to the outside through the hot air discharge unit 60.

The hot air supply unit 50 may include a heater 51 that heats the drawn-in air, and intake ducts 52 and 53 that guide the air heated by the heater 51 to flow into the drum 20.

The intake ducts 52 and 53 may include a lower intake duct 52 installed at a lower portion of the drum 20 and a rear intake duct 53 installed at the rear side of the drum 20 and connecting the intake port (not shown) and the lower intake duct 52. The heater 51 may be arranged in the lower intake duct 52 to heat the air drawn into the lower intake duct 53.

The hot air discharge unit 60 may include a fan 61 that draws in hot and humid air in the drum 20, and a discharge duct 62 that guides the air drawn in by the fan 61 to be discharged from the drum. The fan 61 may be accommodated in a blowing case 63. Accordingly, the air having absorbed moisture from the items to be dried through the discharge duct 62 may be discharged to the outside through a discharge port 62a of the discharge duct 62.

The hot air discharge unit 60 may further include a filter duct 64 installed on a lower portion of the front support frame 17, the filter duct 64 being in communication with the inside of the drum 20 on one side and with the blowing case 63 on the other side, and a filter 65 installed in the filter duct to filter out various foreign matter contained in the air passing through the filter duct 64. The filter 65 may be detachably installed in the filter duct 64.

The air having dries the items to be dried in the drum 20 may be discharged into the filter duct 64. The foreign matter contained in the air entering the filter duct 64 may be filtered by the filter 65. A filter grid 66 in the form of a mesh may be installed at an inlet of the filter duct 64.

The drum 20 may be rotatably installed on the rear plate 15. More particularly, the shaft 23 of the drum 20 may be rotatably installed via a bearing assembly 70 installed on the rear plate 15. Accordingly, the drum 20 may be rotatably installed on the rear plate 15 through the shaft 23.

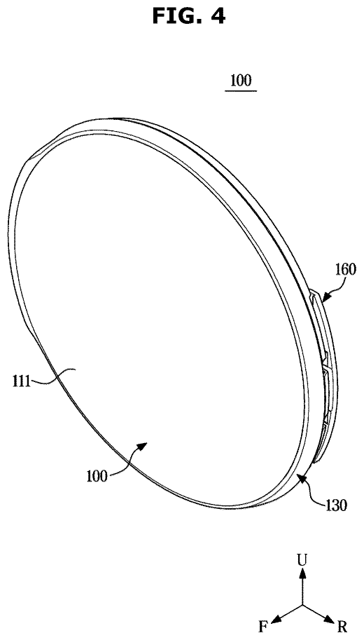

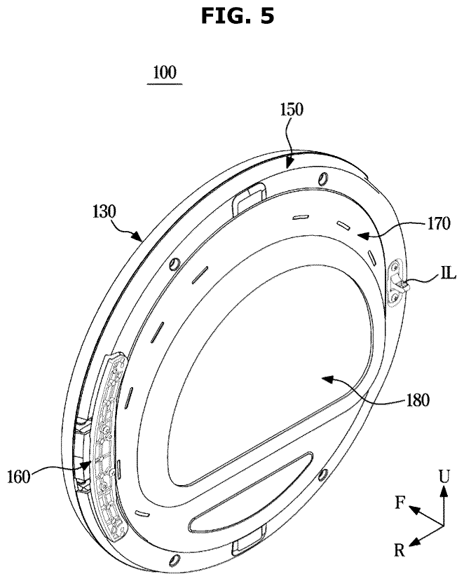

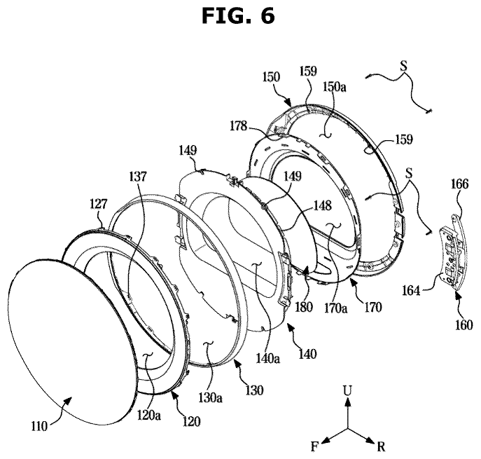

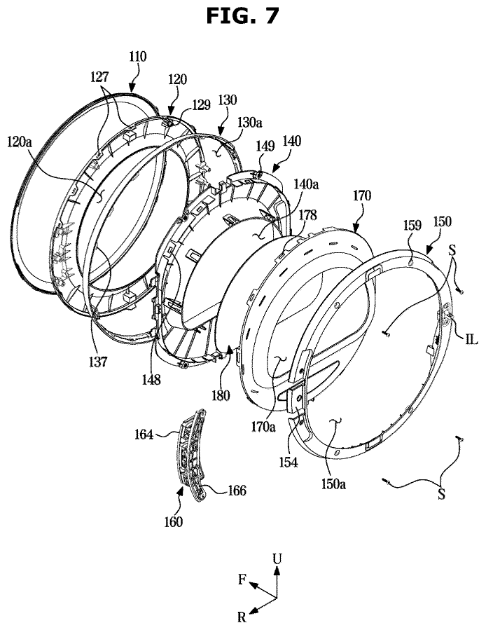

FIG. 4 is a perspective view of the door of the clothes dryer according to an embodiment of the present disclosure shown in FIG. 1. FIG. 5 is a rear perspective view of the door of the clothes dryer according to an embodiment of the present disclosure shown in FIG. 4. FIG. 6 is an exploded perspective view of the door of the clothes dryer according to an embodiment of the present disclosure shown in FIG. 4. FIG. 7 is an exploded perspective view of the door of the clothes dryer according to an embodiment of the present disclosure shown in FIG. 6, viewed from the rear.

Referring to FIGS. 4 to 7, the door 100 may include a front cover 110 configured to cover the inlet 12a (see FIG. 2) and a first rim cover 130 arranged on an edge to cover a rim of the front cover 110.

The front cover 110 may be formed in an approximately circular shape. The front cover 110 may be larger than the inlet 12a to cover the inlet 12a. A user may see that the items to be dried placed in the drum 20 (see FIG. 3) are rotated inside the drum 20 through the front cover 110. In other words, the front cover 110 may be configured such that the inside of the drum 20 is visible.

The first rim cover 130 may be formed in the shape of a band extending along the rim of the front cover 110 to surround a first rim opening 130a formed at the center thereof. The first rim cover 130 may cover the rim of the front cover 110. More particularly, the first rim cover 130 may extend such that a portion viewed from the front becomes wider as it goes from an edge of a front cover body 111 toward the rear.

The door 100 may include a cover supporter 120 arranged on the rear side of the front cover 110 to support the front cover 110. The cover supporter 120 may be arranged at an inner side of the first rim cover 130.

The cover supporter 120 may include a supporter opening 120a at the center. The cover supporter 120 may be formed to surround the supporter opening 120a and may bend rearwardly toward the center of the supporter opening 120a. The cover supporter 120 may include a supporter boss portion 129 formed rearwardly. The supporter boss portions 129 may be provided in a plurality. The cover supporter 120 may include an insertion portion 127 configured to be coupled with the first rim cover 130.

The door 100 may include a holder 140 arranged on the rear side of the cover supporter 120 and coupleable to the cover supporter 120. The holder 140 may be rotatably arranged to the cabinet 10 (see FIG. 1) by a door hinge 160. The holder 140 may be formed to seal the inside and outside of the drum 20.

The holder 140 may include a holder opening 140a. The holder opening 140a may communicate with the supporter opening 120a.

The holder 140 may include a holder boss portion 149. The holder boss portion 149 may be arranged on the rim of the holder 140 and may be provided in a plurality. The holder boss portions 149 may be formed at a positions corresponding to the supporter boss portions 129 of the cover support 120.

The door 100 may include a second rim cover 150 arranged on the rear side of the first rim cover 130.

The second rim cover 150 may be arranged on the rear side of the first rim cover 130 and may be formed in a substantially circular rim shape. The second rim cover 150 may be arranged at the rim of the holder 140. The second rim cover 150 may cover the rim of the holder 140 to protect the rim of the holder 140.

The second rim cover 150 may include a second rim opening 150a. The holder 140 may be positioned in the holder opening 150a, and the second rim cover 150 may bend rearwardly to cover a portion of the rear from the rim of the holder 140.

The second rim cover 150 may be connected to the first rim cover 130. In other words, the second rim cover 150 may be arranged on the rear side of the first rim cover 130.

The second rim cover 150 may be coupled to the cover supporter 120 to secure the holder 140 to the cover supporter 120. The second rim cover 150 may include a second rim boss portion 159 formed for insertion of a screw S.

The second rim boss portion 159 may be formed to correspond to the holder boss portion 149 and may be formed to correspond to the supporter boss portion 129.

The door 100 may include the door hinge 160. The door hinge 160 may include a cabinet coupling portion 166 arranged to be coupleable to the cabinet 10, and a holder coupling portion 164 arranged on the front side of the cabinet coupling portion 166 and supported by the holder 140 and the second rim cover 150.

The cabinet coupling portion 166 may be formed to extend along a portion of a circular circumference. The holder coupling portion 164 may be coupled to a hinge shaft of the cabinet coupling portion 166. In other words, the holder coupling portion 164 may be formed to cover the hinge shaft. The holder coupling portion 164 may be formed in an approximately cuboidal shape.

The cabinet coupling portion 166 may be arranged on the rear side of the second rim cover 150, and the holder coupling portion 164 may be arranged on the front side of the second rim cover 150. In other words, a portion of the second rim cover 150 may be arranged between the holder coupling portion 164 and the cabinet coupling portion 166.

The door 100 may include a rear cover 170 surrounded by the second rim cover 150. The rear cover 170 may include an opening having an approximately semi-circular shape. An opening 170a of the rear cover 170 may be covered by the barrier member 180. In other words, the rear cover 170 may be formed to surround the barrier member 180, and the rear cover 170 may be coupled to the barrier member 180.

The rear cover 170 may include a protrusion hole 178. The protrusion holes 178 may be provided in a plurality and spaced apart from each other. The holder 140 may include a rear protrusion 148. The rear protrusion 148 may be shaped like a protrusion and may be inserted into the protrusion hole 178. As a result, the rear cover 170 and the holder 140 may be coupled together.

As shown in FIG. 5, in response to a screw S being inserted into the second rim boss portion 159 and passing through the holder boss portion 149 and the supporter boss portion 129, the configurations of the front cover 110, the cover supporter 120, the first rim cover 130, the holder 140, the second rim cover 150, the door hinge 160, the rear cover 170, and a glass 180 may be coupled together.

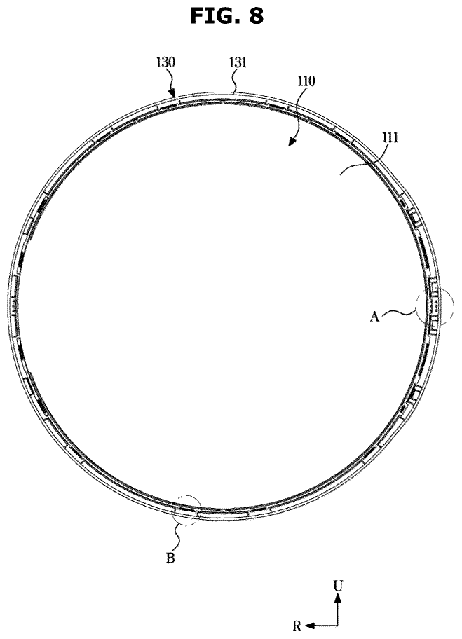

FIG. 8 is a rear view illustrating a state in which the front cover and the first rim cover are coupled, according to an embodiment of the present disclosure shown in FIG. 7.

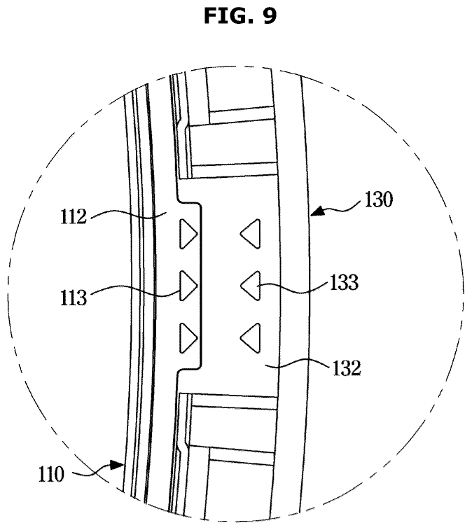

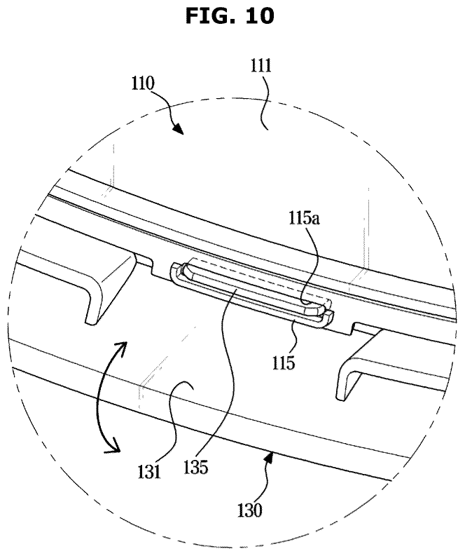

FIG. 9 is an enlarged view of portion A of the front cover and the first rim cover according to an embodiment of the present disclosure shown in FIG. 8. FIG. 10 is an enlarged view of portion B of the front cover and the first rim cover according to an embodiment of the present disclosure shown in FIG. 8.

Hereinafter, with reference to FIGS. 8 to 10, the coupling of the front cover 110 and the first rim cover 130 will be described in detail.

Referring to FIGS. 8 to 10, the first rim cover 130 may be coupled to the rim of the front cover 110. The front cover 110 may include a front cover body 111 having a circular shape, and a coupling portion 115 including a plurality of coupling holes 115a provided along the circumferential direction of the front cover body 111. The coupling holes 115a may be formed to be coupled to the first rim cover 130.

The first rim cover 130 may include a first rim body 131 extending in a circularly shaped band. The first rim body 131 may form the first rim opening 130a. A plurality of coupling protrusions 135 arranged to be spaced apart from each other corresponding to an extension direction of the first rim body 131 may be arranged along the circumferential direction of the first rim body 131. The coupling protrusion 135 may protrude rearwardly from the first rim body 131.

The coupling protrusions 135 may be inserted into the coupling holes 115a, so that the coupling protrusions 135 and the coupling portion 115 may be coupled to each other. The coupling protrusions 135 and the coupling portion 115 may be arranged along the circumferential direction, so that a portion of the coupling portion 115 may be supported by the coupling protrusions 135 in the circumferential direction. As a result, the first rim cover 130 may be coupled to the edge side of the front cover 110, so that the front cover 110 and the first rim cover 130 may be temporarily fixed.

In addition, since the coupling protrusions 135 have elasticity, they may be more easily decoupled from the coupling holes 115a. In other words, when the coupling protrusions 135 are subjected to a forward force, they may be pulled out of the coupling holes 115a, so that the front cover 110 and the first rim cover 130 may be more easily separated from each other.

Because both the front cover 110 and the first rim cover 130 may be formed in a circular shape, the positions of the plurality of coupling holes 115a and the positions of the plurality of coupling protrusions 135 may need to correspond to each other. To this end, a portion for guiding the positions of the front cover 110 and the first rim cover 130 to correspond to each other may be required. The first rim cover 130 may be provided with a first guide portion 133 formed on an inner surface 132 facing the first rim opening 130a.

The front cover 110 may include a second guide portion 113 formed on a guide protrusion 112 protruding radially outwardly from the cover body 111. The second guide portion 113 may be formed at a position corresponding to the first guide portion 133.

As shown in the drawings, the first guide portion 133 may be provided in the shape of an arrow embossed on the inner surface 132 and directed toward the center in the circumferential direction. The second guide portion 113 may be provided in the shape of an arrow embossed on the guide protrusion 112 and directed outwardly in the circumferential direction.

In other words, when the direction of the arrow pointed by the first guide portion 133 and the direction of the arrow pointed by the second guide portion 113 are in opposite directions, the coupling protrusions 135 of the first rim cover 130 may be positioned corresponding to the position of the coupling holes 115a of the front cover 110, and thus the coupling protrusions 135 may be more easily inserted into the coupling holes 115a.

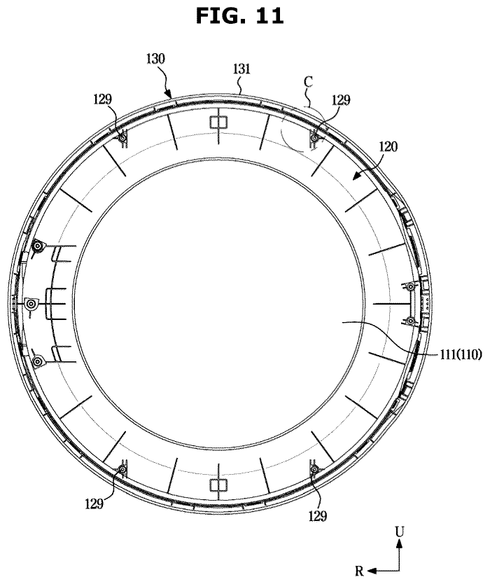

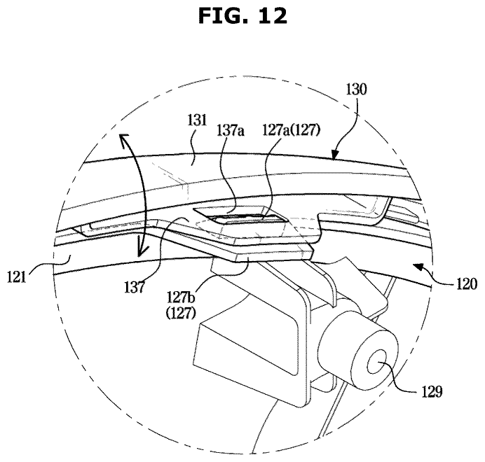

FIG. 11 is a rear view illustrating a state in which the front cover, the first rim cover, and the cover supporter are coupled, according to an embodiment of the present disclosure shown in FIG. 7. FIG. 12 is an enlarged view of portion C of the first rim cover and the cover supporter according to an embodiment of the present disclosure shown in FIG. 11.

With reference to FIGS. 11 and 12, the coupling structure of the first rim cover 130 and the cover supporter 120 coupled to the front cover 110 will be described in detail.

Referring to FIGS. 11 and 12, the first rim cover 130 may include a fixing member 137 protruding rearwardly from the first rim body 131. The fixing members 137 may be formed in a plurality along the circumferential direction of the first rim body 131 and may be spaced apart from each other. The fixing members 137 may each form an insertion hole 137a. The insertion hole 137a may be formed for insertion of an insertion protrusion 127a of the cover supporter 120.

The cover supporter 120 may include the insertion portion 127 protruding rearwardly from a supporter body 121 along a rim of the supporter body 121. The insertion portions 127 may correspond to the number of fixing members 137. The insertion portions 127 may be provided in a plurality and may be spaced apart from each other along the circumferential direction of the supporter body 121.

The insertion portions 127 may each include a support protrusion 127b and the insertion protrusion 127a extending radially outwardly from the support protrusion 127b. The insertion protrusion 127a may be formed to be inserted into the insertion hole 137a. The insertion protrusion 127a may protrude from the support protrusion 127b toward the first rim cover 130 to be coupled to the first rim cover 130. The insertion portion 127 may include a rib to increase the rigidity of the insertion protrusion 127a.

Due to the structure of the pluralities of the insertion projections 127a and the insertion holes 137a of the fixing member 137, which are arranged in the circumferential direction, the cover supporter 120 and the first rim cover 130 may be coupled. As a result, the cover supporter 120 may be coupled to the first rim cover 130 coupled with the front cover 110.

Meanwhile, the insertion protrusions 127a may have elasticity, so that they may be more easily pulled out of the insertion holes 137a. When the rear portion of the fixing member 137 is subjected to a forward force, the insertion protrusions 127a having elasticity may be ejected from the insertion holes 137a, so that the first rim cover 130 and the cover supporter 120 may be relatively easily coupled and uncoupled.

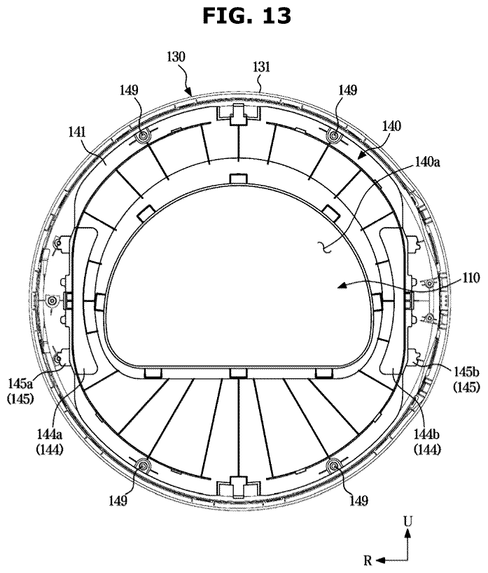

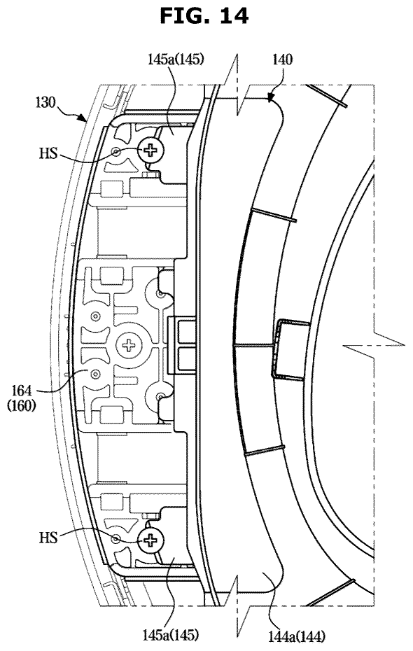

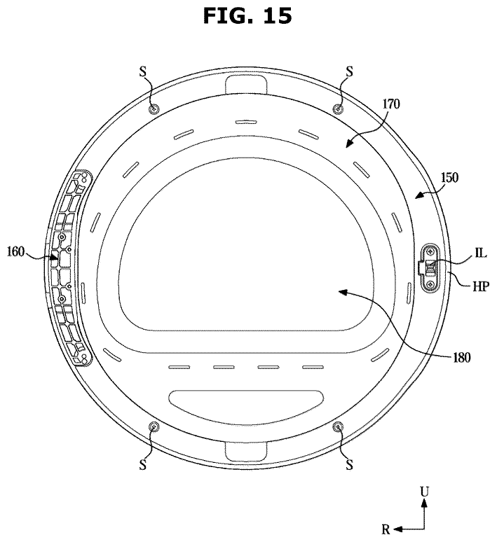

FIG. 13 is a rear view illustrating a state in which the front cover, the first rim cover, the cover supporter, and the holder are coupled, according to an embodiment of the present disclosure shown in FIG. 7. FIG. 14 is an enlarged view of the holder coupling portion of the door hinge according to an embodiment of the present disclosure shown in FIG. 13. FIG. 15 is a rear view of the door according to an embodiment of the present disclosure shown in FIG. 4.

With reference to FIGS. 13 to 15, a structure in which the first rim cover 130 with the front cover 110 and the cover supporter 120 thereto, and other configurations, such as the holder 140 or the like, are coupled to be connected to the door 100 will be described in detail.

Referring to FIGS. 6, 7, and 13 to 15, the holder 140 may be arranged on the rear side of the cover supporter 120 coupled to the first rim cover 130. The holder coupling portion 164 of the door hinge 160 may be arranged between the cover supporter 120 and the holder 140, so that the door hinge 160 and the holder 140 may be coupled.

The holder 140 may include a seat portion 144 formed on each of the left and right sides. The seat portion 144 may be recessed rearwardly from a holder body 141 to form a seating groove 146. The seat portion 144 may be a portion in which the holder coupling portion 164 may be seated, and the seating groove 146 may be a space in which a portion of the holder coupling portion 164 may be seated.

The seat portion 144 may include a first seat portion 144a arranged on the right side of the holder body 141 and a second seat portion 144b arranged on the left side of the holder body 141. The first seat portion 144a and the second seat portion 144b may be formed symmetrically to each other with respect to the holder opening 140a.

The first seat portion 144a and the second seat portion 144b may each be formed such that the holder coupling portion 164 of the door hinge 160 may be seated thereon. In other words, the holder coupling portion 164 may be seated on the first seat portion 144a, or may be seated on the second seat portion 144b by rotating the door hinge 160 180 degrees clockwise or counterclockwise from the holder body 141.

As shown in FIG. 13, in response to the holder coupling portion 164 being seated on the first seat portion 144a, an insertion locker portion IL of the second rim cover 150 may be positioned in the second seat portion 144b. Conversely, in response to the holder coupling portion 164 being seated on the second seat portion 144b, the insertion locker portion IL of the second rim cover 150 may be positioned in the first seat portion 144a.

In such a structure, the reason for allowing the door hinge 160 to be coupleable to both the right and left sides of the holder body 141 is that rotation of the door 100 clockwise or counterclockwise about the cabinet 10 (see FIG. 1) may occur depending on the surrounding situation, and user convenience may vary accordingly.

The holder 140 may include a support portion 145 protruding from the first seat portion 144a and the second seat portion 144b in a direction away from the first seat portion 144a and the second seat portion 144b.

The support portion 145 may include a first support portion 145a connected to the first seat portion 144a and a second support portion 145b connected to the second seat portion 144b. Either of the first support portion 145a and the second support portion 145b may support the holder coupling portion 164 by guiding a hinge screw HS for coupling the holder coupling portion 164 to the holder 140 and, at the same time, covering the rear side of the holder coupling portion 164.

The holder 140 coupled to the door hinge 160 may be moved from the rear to the front of the cover supporter 120 to be arranged so that the positions of the supporter boss portion 129 of the cover supporter 120 and the holder boss portion 149 correspond to each other.

By inserting the rear protrusions 148 of the holder 140 into the protrusion holes 178 of the rear cover 170, the rear cover 170 coupled to the barrier member 180 may be coupled to the holder 140.

The rear protrusions 148 may be provided in a plurality along the rim of the holder body 141, and the protrusion holes 178 may also be provided in a plurality corresponding to the number and position of the rear protrusions 148.

The second rim cover 150 may be moved forwardly from the rear of the rear cover 170 toward the first rim cover 130 to encircle the rim of the rear cover 170. At this time, the second rim boss portion 159 of the second rim cover 150 may be positioned to correspond to the holder boss portion 149 and the supporter boss portion 129. The cover supporter 120, the holder 140, and the second rim cover 150 may be coupled to each other by the screw S passing through the second rim boss portion 159, the holder boss portion 149, and the supporter boss portion 129.

Meanwhile, the rear cover 170 may include iron (Fe). More particularly, the rear cover 170 may be formed of an iron plate, and according to such structure, the air inside the drum 20 of the heat pump type clothes dryer 1 according to the present disclosure may be relatively hotter than the clothes dryer having a heat exchanger. The rear cover 170 in contact with such air may be formed of an iron plate to improve durability. Similarly, the material of the barrier member 180 may also be formed of an iron plate.

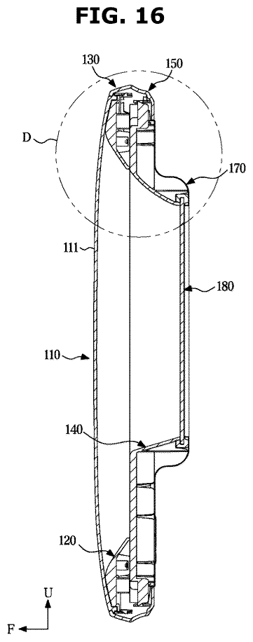

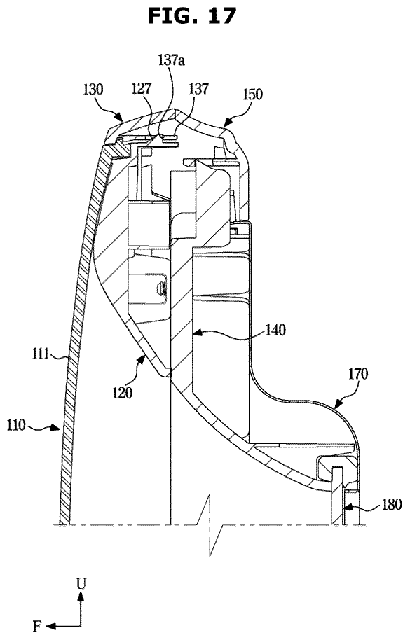

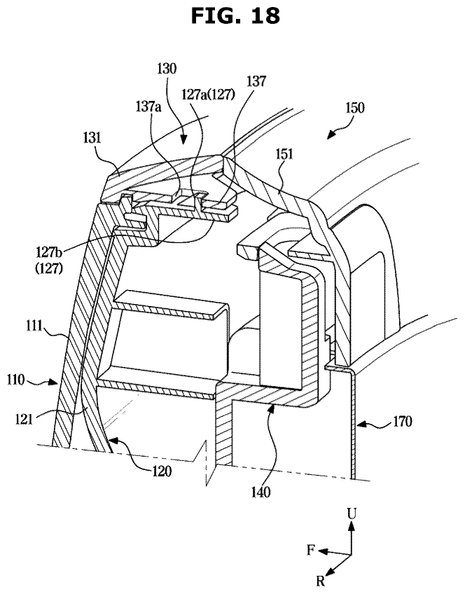

FIG. 16 is a side cross-sectional view of the door according to an embodiment of the present disclosure shown in FIG. 15. FIG. 17 is an enlarged view of portion D shown in FIG. 16. FIG. 18 is a perspective view illustrating an exploded cross-section of the door according to an embodiment of the present disclosure shown in FIG. 15.

Referring to FIGS. 16 to 18, the first rim cover 130 positioned on the rim of the front cover 110 and the second rim cover 150 positioned on the rim of the holder 140 may only come into contact with each other, but may not be coupled.

More particularly, the cover supporter 120, the holder 140, and the second rim cover 150 may be coupled by the screw S (see FIGS. 6 and 7). The first rim cover 130 may be coupled with the front cover 110, and the first rim cover 130 may be coupled with the cover supporter 120.

However, the first rim cover 130 may come into contact with the second rim cover 150 and be connected to each other, but may not be coupled to each other. According to such a structure, the first rim cover 130 may be separated from the second rim cover 150 by separating the cover supporter 120 from the holder 140. In response to the second rim cover 150 being separated from the holder 140 or the cover supporter 120, the first rim cover 130 may be separated from the second rim cover 150. In addition, in response to the cover supporter 120 being separated from the second rim cover 150 or the holder 140, the first rim cover 130 coupled to the front cover 110 and the cover supporter 120 may be separated from the second rim cover 150 and then separated from the front cover 110 or the cover supporter 120.

On the other hand, the first rim cover 130 and the front cover 110 may have relatively weak durability among the configurations of the door 100, and thus there is a risk of damage. However, in a case where the first rim cover 130 is easily separated from the second rim cover 150, only some configurations, including the first rim cover 130, may be replaced at a relatively lower cost during the repair and service.

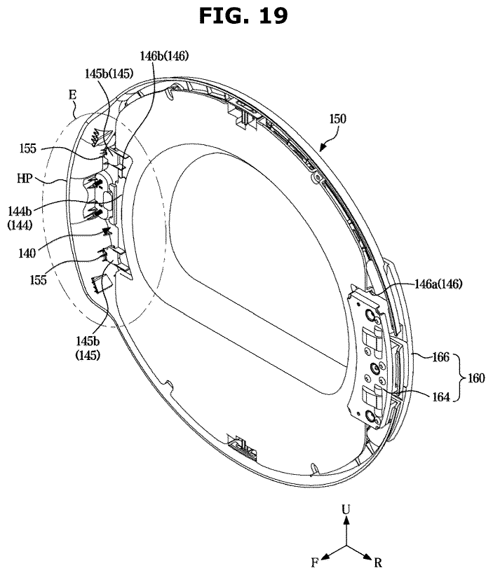

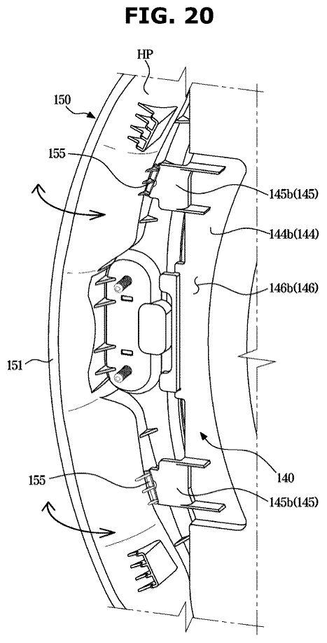

FIG. 19 is a front view illustrating the second rim cover according to an embodiment of the present disclosure shown in FIG. 4, with the front cover and the cover supporter and the first rim cover omitted. FIG. 20 is an enlarged perspective view of portion E shown in FIG. 19.

Referring to FIGS. 19 and 20, the holder coupling portion 164 of the door hinge 160 may be positioned in a first seating groove 146a. In response to the door hinge 160 being seated in the first seating groove 146a, a handle portion Hp of the door 100 (see FIG. 1) may be positioned in a second seating groove 146b.

The handle portion Hp may be formed to bend forwardly so that the door hinge 160 may be coupled to the cabinet 10 to easily rotate the door 100 clockwise or counterclockwise.

The second rim cover 150 may include a guide rib 155 protruding from the handle portion Hp toward the holder 140. The guide rib 155 may be positioned adjacent to the handle portion Hp. The guide rib 155 may be formed to be caught by the support portion 145. The guide rib 155 may protrude from an inner surface of the handle portion Hp toward the holder 140. The guide rib 155 may be elastic and may include a rib such as a flange shape to improve a certain strength.

The guide ribs 155 may be provided in a plurality, which may corresponds to the number of the support portions 145. The guide ribs 155 may be used to temporarily fix the second rim cover 150 to the holder 140.

More particularly, since the door 100 (see FIG. 1) is a structure in which multiple configurations are coupled, the coupling force of the edge portion where the screw S coupling is not performed may be relatively weak. To this end, the guide ribs 155 may be formed to be caught on either the first support portion 145a or the second support portion 145b to prevent a gap from forming in the edge portion of the door 100. Such a structure may improve the overall appearance of the door 100, thereby improving the durability of the door 100 and increasing consumer satisfaction.

In addition, when the second rim cover 150 is released from the holder 140, the guide ribs 155 may be separated from the support portion 145 as the second rim cover 150 is pushed radially outward.

The guide ribs 155 may guide the second rim cover 150 to be more easily coupled to the holder 140 and at the same time, may allow the second rim cover 150 to be more easily separated from the holder 140.

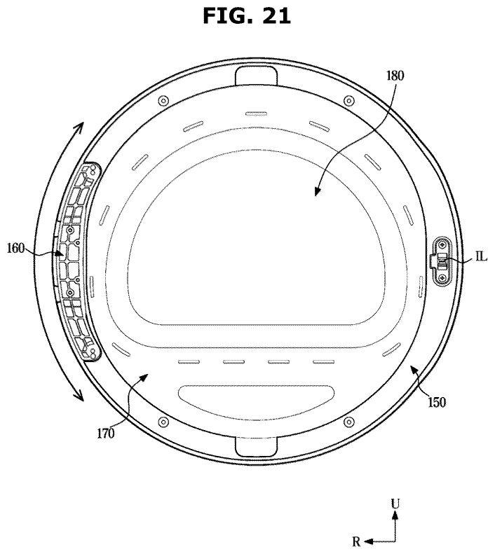

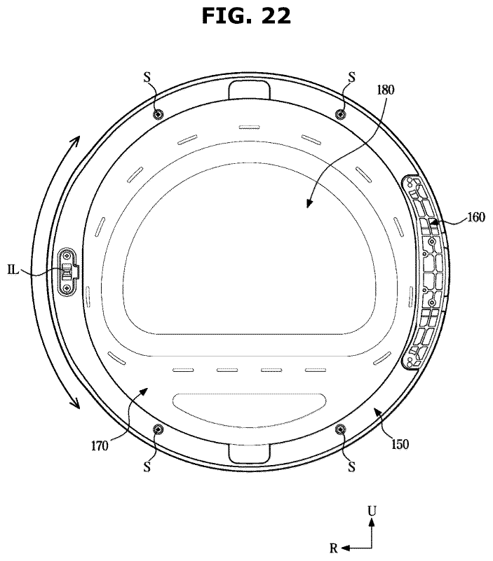

FIGS. 21 and 22 are rear views illustrating reverse operation of the door according to an embodiment of the present disclosure. The reverse operation of the door 100 will be described in detail with reference to FIGS. 21 and 22.

Referring to FIGS. 21 and 22, the door 100 (see FIG. 1) may need to be rotatable clockwise and counterclockwise to more easily load the items to be dried into the drum 20 through the inlet 12 due to the surrounding furniture and other configurations at the location where the cabinet 10 is installed.

The front cover 110 may have a circular shape and may rotate 180 degrees clockwise or counterclockwise about the center of rotation, and thus the direction of rotation of the door 100 may be reversed simply by symmetrically positioning the door hinge 160 relative to the holder 140.

As shown in FIG. 15, the screw S may be loosened from the second rim cover 150 to allow the door hinge 160 to be coupled to the left side of the holder 140 from the door hinge 160 being coupled to the right side of the holder 140.

In response to the screw S being removed from the second rim cover 150, the configuration of the second rim cover 150, the rear cover 170, and the glass 180 may be separated from the holder 140, the cover supporter 120, the front cover 110, and the first rim cover 130.

In such a state, the door hinge 160 may be rotated 180 degrees clockwise or counterclockwise with respect to the holder 140, so that the door hinge 160 may be positioned on the left side of the holder 140.

Then, the second rim cover 150, the front cover 110 and the cover supporter 120 coupled to the first rim cover 130 may be rotated 180 degrees clockwise or counterclockwise with respect to the holder 140. The second rim cover 150 may be coupleable to the holder 140 as the door hinge 160 is rotated with respective to the holder 140. In response to the screw S being inserted to correspond to the second rim boss portion 159, the holder boss portion 149 and the supporter boss portion 129, the door 100 that may be rotated counterclockwise in the cabinet 10 as shown in FIG. 15 may be changed to be rotated clockwise in the cabinet 10 as shown in FIG. 22.

Such a structure may, as described above, allow the rotation of the door 100 to be easily changed for different environments, thereby improving user satisfaction and making it easier to install the clothes dryer 1.

In addition, the coupling position of the door hinge 160 may also be more easily changed as the second rim cover 150 may be more easily released from the first rim cover 130.

The door hinge 160 coupled to the first seat portion 144a may be seated on the second seat portion 144b by separating the second rim cover 150 from the cover supporter 120. In other words, in response to the separation of the second rim cover 150 from the cover supporter 120, the door hinge 160 seated on the second seat portion 144b may be supported by the second support portion 145b.

While the present disclosure has been particularly described with reference to exemplary embodiments, it should be understood by those of skilled in the art that various changes in form and details may be made without departing from the spirit and scope of the present disclosure.

1. A clothes dryer comprising:
a cabinet including an inlet; and
a door to be rotatably arranged on the cabinet to open or close the inlet;
wherein the door comprises:
a holder to be rotatably arranged on the cabinet,
a front cover,
a cover supporter to be coupled to the holder so that while the cover supporter is coupled to the holder, the cover supporter is arranged between the front cover and the holder to support the front cover,
a first rim cover configured to be coupled to the front cover so that while the first rim cover is coupled to the front cover, the first rim cover covers a rim of the front cover, and
a second rim cover configured to be coupled to a rim of the holder so that while the second rim cover is coupled to the holder, the second rim cover is connected to the first rim cover,
wherein the first rim cover is separable from the second rim cover by separating the cover supporter from the holder.

2. The clothes dryer of claim 1, wherein
the first rim cover is coupled to the cover supporter, and
while the first rim cover coupled to the front cover and the cover supporter, the first rim cover is separated from the second rim cover by separating the cover supporter from the second rim cover.

3. The clothes dryer of claim 1, wherein
the cover supporter comprises an insertion protrusion protruding toward the first rim cover to be coupled to the first rim cover, and
the first rim cover comprises an insertion hole formed to allow the insertion protrusion to be inserted.

4. The clothes dryer of claim 1, wherein
the front cover comprises a coupling hole, and
the first rim cover comprises a coupling protrusion formed to be inserted into the coupling hole of the front cover.

5. The clothes dryer of claim 1, further comprising a door hinge configured to rotate the door relative to the cabinet, the door hinge including a holder coupling portion coupled to the holder, and
the holder comprises a seat portion formed to allow the holder coupling portion to be seated, and a support portion configured to support the holder coupling portion and protruding from a rim of the seat portion.

6. The clothes dryer of claim 5, wherein
the seat portion and the support portion are a first seat portion and a first support portion, respectively,
the first seat portion and the first support portion are formed on one side of the holder, and
the holder further includes a second seat portion corresponding to the first seat portion and formed on another side of the holder, and a second support portion corresponding to the first support portion and formed on the other side of the holder.

7. The clothes dryer of claim 6, wherein the holder coupling portion is seated on one of the first seat portion and the second seat portion.

8. The clothes dryer of claim 6, wherein the door hinge seated on the first seat portion is seatable on the second seat portion by separating the second rim cover from the cover supporter.

9. The clothes dryer of claim 6, wherein the door hinge seated on the second seat portion is supported by the second support portion by separating the second rim cover from the cover supporter.

10. The clothes dryer of claim 6, wherein the second rim cover comprises a guide rib formed to be caught on one of the first support portion and the second support portion.

11. The clothes dryer of claim 10, wherein the guide rib protrudes toward the seat portion.

12. The clothes dryer of claim 11, wherein the second rim cover is coupled to the holder as the door hinge rotates relative to the holder.

13. The clothes dryer of claim 4, wherein
the first rim cover comprises a first guide portion configured to guide a position of the front cover to allow the coupling protrusion to be inserted into the coupling hole, and
the front cover comprises a second guide portion formed at a position corresponding to the first guide portion.

14. The clothes dryer of claim 10, wherein the second rim cover further comprises a handle portion formed on one side adjacent to the guide rib.

15. The clothes dryer of claim 1, further comprising a rear cover positioned further rearwardly than the holder and formed of iron (Fe).
